(19) United States
(12) Patent Application Publication
(10) Pub. No.: US 2022/0333915 A1
(43) Pub. Date: Oct. 20, 2022

(54) INTERNAL DEFORMATION ANALYSIS EXPERIMENTAL DEVICE AND METHOD FOR THREE-DIMENSIONAL PARTICLE MATERIAL

(71) Applicant: QINGDAO UNIVERSITY OF TECHNOLOGY, Qingdao, Shandong (CN)

(72) Inventors: Fanxiu CHEN, Qingdao (CN); Yichen ZHONG, Qingdao (CN); Xinya GAO, Qingdao (CN); Yusong MIAO, Qingdao (CN); Piyang LIU, Qingdao (CN); Yong YU, Qingdao (CN); Wei SHI, Qingdao (CN); Lanqin WANG, Qingdao (CN)

(73) Assignee: QINGDAO UNIVERSITY OF TECHNOLOGY, Qingdao, Shandong (CN)

(21) Appl. No.: 17/625,450

(22) PCT Filed: Mar. 31, 2021
(86) PCT No.: PCT/CN2021/084378

§ 371 Date: Jan. 7, 2022

(30) Foreign Application Priority Data
Dec. 14, 2020 (CN) 2020114650477

(51) Int. Cl. G01B 11/16; G01N 21/64

(52) U.S. Cl. CPC G01B 11/16; G01N 21/645

(57) ABSTRACT

An internal deformation analysis experimental device and method for a three-dimensional particle material, including an internal deformation analysis experimental device for a three-dimensional particle material includes: several particles, which are transparent solids; an infiltration liquid, the refractive index of the particles being the same as that of the infiltration liquid; a container, configured to accommodate the particles and the infiltration liquid; a laser device, arranged on an outer side of the container, the infiltration liquid being able to generate fluorescent light when laser emitted by the laser device irradiates the infiltration liquid; a recording apparatus, arranged on the outer side of the container and configured to collect and acquire a sequential image of the particles; and a computing terminal, the recording apparatus sending the acquired sequential image of the particles to the computing terminal, and the computing terminal constructing a three-dimensional particle system through the sequential image of the particles.

### TECHNICAL FIELD

The present invention relates to the field of three-dimensional internal deformation analysis of a particle material, in particular to an internal deformation analysis experimental device and method for a three-dimensional particle material.

### BACKGROUND

The description in this section only provides background information related to the present invention and does not necessarily constitute the prior art.

From the viewpoint of mechanics, a bulk system exhibits a mechanical behavior which is far more complex than that of a general material system such as an ordinary liquid and an elastic solid. A discrete-state particle system consisting of a large number of particles exhibits peculiar mechanical phenomena and motion laws such as shear zones, self-organized criticality, relaxation, solid-like to fluid-like transformation and flowing deformation that are different from solids, liquid, and gas. However, an existing theory assumed on the basis of a continuum cannot give an explanation well. In fact, there is not yet a clear understanding of the basic laws of a particle system. As the Nobel Laureate Processor Gennes in France pointed out in 1999, “We have yet to understand everything about the dissipative non-equilibrium system of particles, and the overall level of cognition is just like our understanding of solid physics in the 1930s.” The reason is directly related to unique mechanical properties of the particle system itself.

With the development of computer and image processing technologies, visual optical testing methods have been greatly developed. The most advanced methods are applied to the researches of a non-uniform structure of the particle system, and conclusive evidence for the non-uniform structure of the particle system is found. At this time, a digital image correlation (DIC) correlation method is introduced to field of mechanical studies on particulate matters. Chauve et al. studied the evolution of a local non-uniform strain field around an intra particle crack in polycrystalline ice at the beginning of Tertiary creep on the basis of the DIC for the first time. Hurley et al. improved the granular element method (GEM) and described transmission of internal force of opaque particles with any shape and texture in combination with the DIC. Subsequently, Chen et al. and Marteau et al. carried out experiments, combined the DIC method with the GEM method to calculate and obtain an internal contact force and particle kinematic parameters of a two-dimensional opaque particle system, and analyzed an identified force chain network and its evolution. By combining the DIC with the GEM, Zhang Xingyi et al. gave distribution characteristics of a cross-sectional strand contact force of a CICC conductor under a lateral pressure, and performed statistical analysis on a size and a direction of the contact force chain.

With the development of science and technology, some high-tech non-contact means have also been used to test mechanical properties of the particle system, such as acoustic emission, scanning electron microscope, three-dimensional X-ray diffraction, X-ray computed tomography, and nuclear magnetic resonance. However, these methods have high requirements for environments and apparatuses, and the scanning time is long, especially in-situ loading cannot be realized, which brings much inconvenience to subsequent data processing and analysis. Therefore, these methods are not widely used.

In general, the development of basic researches on the bulk particle materials is closely related to the progress of an experimental technology. Although some achievements have been made in terms of force chain recognition and the influence of size, shape, elastic modulus, Poisson's ratio and other parameters of particles on the force chain network, the inventor found that the existing researches mainly focus on a two-dimensional particle system and are in an initial stage. Particle materials in reality are all three-dimensional, which require researches on the meso-scale of a three-dimensional particle system. At the present stage, there is no simple experimental method to realize the quantitative calculation of the contact force of the three-dimensional particle system and the force chain recognition. It is difficult to realize the analysis of meso-structure parameters of the real three-dimensional particle system. The development of these researches is extremely important for the discussion of the evolution and stability of a force chain of the particle system.

### SUMMARY

For the deficiencies in the existing art, the present invention aims to provide an internal deformation analysis experimental device for a three-dimensional particle material. An imaging optical experimental system is constructed to perform laser tomographic scanning irradiation on a fluorescent particle system; a sequential image of the internal of the particle system is obtained through a recording apparatus; and it is favorable for revealing the law of quantitative influence of a microscopic response of the particle system.

In order to realize the foregoing objectives, the present invention adopts the technical scheme as follows:

An internal deformation analysis experimental device for a three-dimensional particle material includes:

several particles, which are transparent solids;

an infiltration liquid, the refractive index of the particles being the same as that of the infiltration liquid;

a container, configured to accommodate the particles and the infiltration liquid;

a laser device, arranged on an outer side of the container, the infiltration liquid being able to generate fluorescent light when laser emitted by the laser device irradiates the infiltration liquid;

a recording apparatus, arranged on the outer side of the container and configured to collect and acquire a sequential image of the particles; and

a computing terminal, the recording apparatus sending the acquired sequential image of the particles to the computing terminal, and the computing terminal analyzing the sequential image of the particles, constructing a three-dimensional particle system, and acquiring three-dimensional internal deformation parameters of the three-dimensional particle system.

In the above experimental device, the imaging optical experimental device is constructed; the particles simulate a bulk; the container accommodates the particles and the infiltration liquid; the laser device emits the laser; the recording apparatus can acquire the sequential image of the particles; and the computing terminal performs relevant analysis to obtain positions, deformation, and trajectory information of the particles of the three-dimensional particle system in a set state.

In the above-mentioned internal deformation analysis experimental device for a three-dimensional particle material, the container includes a container wall; and a movable top plate capable of moving up and down relative to the container wall is arranged in the container wall. With the movable top plate, it is convenient for providing the infiltration liquid and the particles in the container wall and convenient for applying a load to the infiltration liquid and the particles through the movable top plate.

In the above-mentioned internal deformation analysis experimental device for a three-dimensional particle material, a displacement sensor and a force sensor are mounted on the movable top plate and are configured to measure magnitudes of a vertical stress and displacement; the displacement sensor and the force sensor are connected to a controller, respectively; and the controller is provided with a display screen for displaying numerical values detected by the displacement sensor and the force sensor, which facilitates experiments.

In the above-mentioned internal deformation analysis experimental device for a three-dimensional particle material, the movable top plate is connected to a force application mechanism; the force application mechanism is connected to the controller; the force application mechanism may be a linear moving unit, such as an electric cylinder or other mechanisms; and the force application mechanism is connected to the movable top plate to realize application of the load.

In the above-mentioned internal deformation analysis experimental device for a three-dimensional particle material, the recording apparatus is a charge coupled device (CCD) camera; a lens of the camera is provided with a light filter; and the light filter allows light having a wavelength greater than that of the laser emitted by the laser device to pass; and

an image plane of the CCD camera is parallel to the laser emitted by the laser device.

In the above-mentioned internal deformation analysis experimental device for a three-dimensional particle material, the laser device is mounted on a linear drive mechanism connected to the controller, and the linear drive mechanism drives the laser device to move from one side to the other side, so as to facilitate the experiments conducted through the experimental device.

In a second aspect, the present invention further provides an internal deformation analysis method for a three-dimensional particle material, in which the experimental device is used.

The above-mentioned internal deformation analysis method for a three-dimensional particle material includes:

placing particles and infiltration liquid into the container;

turning on the laser device, emitting laser to the container, applying a set load to a mixed liquid of the particles and the liquid in the container, and collecting, by the recording apparatus, sequential images of multiple layers of the particle system in different load states;

obtaining three-dimensional particle systems in different load states according to the sequential images in different load states, applying operations of a digital volume correlation method on the reconstructed three-dimensional particle systems, and obtaining internal displacement, strain, stress, and other information of the particle system, thus realizing analysis of a three-dimensional internal deformation of the particle system.

In the above analysis method, for the sequential image collected in each load state, the three-dimensional particle systems in different states are obtained through refractive index matching scanning analysis and are then subjected to the operations of the digital volume correlation method, thus obtaining the displacement, stress, and strain of the particle system in the loading process, obtaining the magnitude of a contact force between particles, and analyzing the mechanical characteristics of the particle system in the loading process.

In the above-mentioned internal deformation analysis method for a three-dimensional particle material, the turning on the laser device, emitting laser to the container, and collecting, by the recording apparatus, sequential images of multiple layers of the particle system specifically includes:

along a lengthwise direction of the container, from one side to the other side, moving the laser device once every set distance, and collecting, by the recording apparatus, the sequential images of the multiple layers of the particle system, thus obtaining a three-dimensional particle system in an original state: State 1; and

applying the set load to the mixed liquid of the particles and the liquid in the container, in each load application process, along the lengthwise direction of the container, from one side to the other side, moving the laser device once every set distance, and collecting, by the recording apparatus, the sequential images of the multiple layers of the particle system, thus obtaining three-dimensional particle systems in different load states: State 2, State 3, . . . , State N.

The present invention has the following beneficial effects:

1) In the present invention, the liquid will generate fluorescent light when the laser irradiates it, so that light diffraction occurs at an intersection between a laser irradiation plane and a surface of the particle, and a boundary of the particle will become a clear contour and collected by the recording apparatus; when in-situ loading is performed on the particle bulk, the camera with the image plane parallel to a laser sheet is used to acquire an image of the particle system, thus obtaining the sequential image of the particle; and the computing terminal can reconstruct the three-dimensional particle system through an image processing technology, so as to facilitate the analysis of the three-dimensional particle system.

2) In the present invention, by means of the container, the infiltration liquid and the particles can be accommodated, and transmission of the laser can also be realized without affecting the acquisition of the image by the recording apparatus; and loads with different magnitudes can be applied to the infiltration liquid and the particles in the container through the movable top plate.

3) In the present invention, by means of the linear drive mechanism, the laser device can be driven to move along the lengthwise direction or a width direction of the container, which is favorable for automatic control of the experimental device.

4) In the present invention, by means of the analysis method, the three-dimensional particle system is reconstructed through the computing terminal, and the relevant analysis can be performed on the three-dimensional particle systems in different load states to obtain the displacement, stress, and strain of the particle system in the loading process, thus obtaining the magnitude of the contact force between the particles and analyzing the mechanical characteristics of the particle system in the loading process.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention, and do not constitute an improper limitation of the present invention.

FIG. 1 is a schematic diagram of an internal deformation analysis experimental device for a three-dimensional particle material according to one or more implementations in the present invention.

FIG. 2 is a schematic diagram of a container according to one or more implementations in the present invention.

In the figure: In order to show the position of each portion, the distance or size between each portion is exaggerated. The schematic diagram is only for illustration.

In the drawings: 1: computer; 2: CCD camera; 3: laser device; 4: electric guide rail; 5: container; 6: force sensor; and 7: movable top plate.

### DETAILED DESCRIPTION

It should be pointed out that the following detailed descriptions are all illustrative and are intended to provide further descriptions of the present invention. Unless otherwise specified, all technical and scientific terms used herein have the same meanings as those usually understood by a person of ordinary skill in the art to which the present invention belongs.

It should be noted that the terms used herein are only used for describing specific implementations, and are not intended to limit exemplary implementations of the present invention. As used herein, the singular form is intended to include the plural form, unless the present invention clearly indicates otherwise. In addition, it should further be understood that terms “comprise” and/or “include” used in this specification indicate that there are features, steps, operations, devices, components, and/or combinations thereof.

As described in the background, the problem in the prior art lies in that it is difficult to realize analysis of meso-structure parameters of a real three-dimensional particle system. In order to solve the above technical problem, the present invention provides an internal deformation analysis experimental device and method for a three-dimensional particle material.

### Embodiment I

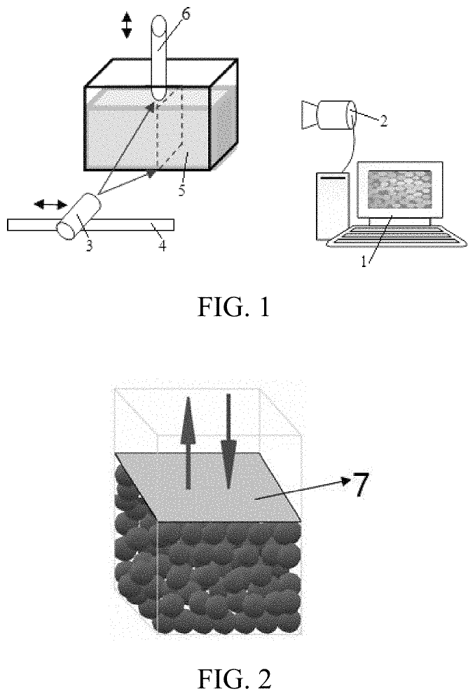

In one typical implementation of the present invention, referring to FIG. 1, an internal deformation analysis experimental device for a three-dimensional particle material includes: several particles, which are transparent solids; an infiltration liquid, the refractive index of the particles being the same as that of the infiltration liquid; a container, configured to accommodate the particles and the infiltration liquid; a laser device 3, arranged on an outer side of the container 5, the infiltration liquid being able to generate fluorescent light when laser emitted by the laser device irradiates the infiltration liquid; a recording apparatus, arranged on the outer side of the container and configured to collect and acquire a sequential image of the particles; and a computing terminal, the recording apparatus sending the acquired sequential image of the particles to the computing terminal, and the computing terminal reconstructing a three-dimensional particle system.

The container 5 includes a container wall. A movable top plate capable of moving up and down relative to the container wall is arranged in the container wall. By means of the movable top plate, it is convenient for providing the infiltration liquid and the particles in the container wall and convenient for applying a load to the infiltration liquid and the particles through the movable top plate.

A displacement sensor and a force sensor 6 are mounted on the movable top plate 7 and are configured to measure magnitudes of a vertical stress and displacement. The displacement sensor and the force sensor are connected to a controller, respectively. The controller has a display screen for displaying numerical values detected by the displacement sensor and the force sensor.

Further, the movable top plate 8 is connected to a force application mechanism. The force application mechanism is connected to the controller. The force application mechanism may be a linear moving unit, such as an electric cylinder or other mechanisms. The force application mechanism is connected to the movable top plate to realize application of the load.

The recording apparatus is a charge coupled device (CCD) camera 2. A lens of the camera is provided with a light filter. The light filter allows light having a wavelength greater than that of the laser emitted by the laser device to pass. An image plane of the CCD camera is parallel to the laser emitted by the laser device.

Further, the laser device is mounted on a linear drive mechanism connected to the controller, and the linear drive mechanism drives the laser device to move from one side to the other side, so as to facilitate the experiments conducted through the experimental device.

Specifically, in some examples, the linear drive mechanism is an electric guide rail 4. The electric guide rail 4 drives the laser device to linearly move.

It is readily comprehensible that the controller may be a programmable logic controller (PLC) or other types of controllers. The controller is configured to control the actions of the linear drive mechanism and the force application mechanism and acquiring relevant data of the sensors.

It should be noted that the computing terminal is a computer 1. The computer 1 may perform refractive index matching scanning analysis on the sequential image of the particle acquired in each loading state to obtain three-dimensional particle systems in different states. Furthermore, digital volume correlation method software is installed inside the computer to further perform digital volume correlation operations on the three-dimensional particle systems to obtain internal displacement, strain, stress, and other information of the particle systems, thus realizing analysis of three-dimensional internal deformation of the particle system.

### Embodiment II

Provided is an internal deformation analysis method for a three-dimensional particle material, in which the internal deformation analysis experimental device for a three-dimensional particle material of Embodiment I is used.

1) Set particles are selected.

In order to realize fluorescence scanning based on a refractive index, the selected particle materials and infiltration liquid have particularity. Firstly, the particle materials need to be transparent, and their refractive index needs to be the same as that of the infiltration liquid. A refractive index difference between a solid phase and a liquid phase of the mixture is required to be less than ±2×10⁻³. Bulk particles are prepared from organic glass. The gravity of the bulk particles is about 0.01 g, where g is the gravitational acceleration.

In some examples, about 20-30 transparent solid balls having a diameter of 7 mm are selected. The solid balls are made of polymethyl methacrylate.

2) Suitable infiltration liquid is selected.

The infiltration liquid is a fluorescent dye liquid, and a peak value of its absorption spectrum shall be matched with a wavelength of a laser agent used. An emission spectrum of the dye is narrower than a dispersion and shall cover an absorption spectrum of a photosensitive element used in a digital camera. In some specific examples, a fluorescent liquid with a refractive index of, for example, 1.45 is selected.

The liquid is a solution of polyvinylpyrrolidone (PVP).

3) The particles and the infiltration liquid are placed into the container.

The particles and the liquid are put into a transparent cuboid container made of an acrylic material. The particles are surrounded by the solution, and a refractive index of the particles is the same as that of the solution, which reduces light refraction at a liquid-particle-liquid interface and improves an optical channel. The particles have a diameter of 5 mm and the gravity of about 0.01 g, where g=9.81 m/s² which is the standard gravitational acceleration. The particle system can be subjected to a compression experiment through the movable top plate of the cuboid container. During the experiment, the CCD camera 2 is used for collecting and acquiring a sequential image of the particles.

Specifically, in the present embodiment, the container 5 is a cuboid made of transparent resin glass, with an edge length of 25 mm×25 mm×15 mm. The top plate of the container is capable of moving up and down, and the displacement sensor and the force sensor are mounted on the top plate and configured to measure the magnitudes of the vertical stress and displacement. A moving speed of the top plate is 1 mm/s.

The camera used is obtained from an AVT Basler fm-14 CCD camera, with a camera resolution of 1200×1600 pixels. The laser device is placed on the linear moving mechanism. An image plane of the CCD camera is parallel to the light emitted by the laser device. The CCD camera is provided with a light filter which allows light having a wavelength greater than that of laser emitted by the laser device to pass, thus preventing the interference of scattered laser that is occasionally detected.

4) An experiment is conducted. The CCD camera is used for collecting sequential images of multiple layers of the particle system and recording the overall state of the particle system in this state. When the particles are infiltrated in the infiltration liquid, black particles will be seen through the camera one by one, but when the laser device is turned on, the infiltration liquid will emit fluorescent light during laser irradiation. The particles themselves are black, and the liquid is pervious to light and is bright in color. Light diffraction occurs at an intersection between a laser irradiation plane and a surface of the particle, and a boundary of the particle will form a clear contour. The laser is moved, and at the same time, the high-resolution CCD camera with an image plane parallel to a laser sheet is used to perform volume scanning on the particle system, so as to collect the sequential image. After each load is applied to the particles according to an experimental plan, it is paused for a few seconds.

4-1) Before the experiment, an experimental system is required to be adjusted at first, the laser device is turned on, and the camera is adjusted in position.

4-2) The laser device is turned on to ensure that the laser device is located at the leftmost side of the particle system. The CCD camera collects a tomographic image 1_0.bmp at this position and saves the same.

4-3) The laser device is moved by 0.5 mm rightwards according to a specified step, and the CCD camera collects a tomographic image 1_1.bmp again and saves the same.

4-4) The laser device is moved by 0.5 mm rightwards in turn, and the CCD collects and obtains sequential tomographic images of the particles and saves the same as 1_2.bmp, 1_3.bmp, . . . , until the tomographic scanning of the entire particle system from left to right is completed. A sequential tomographic image of the particle system from left to right in this load state is saved. This sequential scanning takes several minutes.

4-5) A quasi-static load is applied through the movable top plate. The loaded top plate is moved down by 1 mm and then paused for a few seconds to allow the system to relax, and collection of a sequential image under this load starts. The above steps 4-2) to 4-4) are repeated, and images are sequentially saved as 2_0.bmp, 2_1.bmp, 2_2.bmp, 2_3.bmp, . . . until the entire particle system is scanned.

4-6) The step 4-5) is repeated until the loading is completed.

5) Analysis of three-dimensional internal deformation of the particle system is realized by reconstructing a three-dimensional particle system.

Refractive index matching scanning analysis is performed on each group of tomographic scanning images to obtain three-dimensional particle systems in different states, and digital volume correlation operations are performed on the three-dimensional particle systems to obtain internal displacement, strain, stress and other information of the systems, thus realizing analysis of the three-dimensional internal deformation of the particle systems and analysis of the temporal-spatial evolution law of meso-structure parameters of the particle systems.

5-1) The sequential images obtained in the original state: 1_0.bmp, 1_1.bmp, 1_2.bmp, . . . , are analyzed by using the refractive index matching scanning to obtain a three-dimensional particle system in the original state: State 1.

5-2) The sequential images obtained in different load states are analyzed in sequence by using the refractive index matching scanning to obtain the three-dimensional particle systems in different load states: State 2, State 3, . . . , State N.

5-3) The digital volume correlation analysis is performed on the obtained three-dimensional particle systems in the load states: State 1, State 2, State 3 . . . State N to obtain internal displacement, strain, stress and other information of the particle systems in different states, realizing the analysis of the three-dimensional internal deformation of the bulk material.

The foregoing descriptions are only preferred embodiments of the present invention, but are not intended to limit the present invention. A person skilled in the art may make various alterations and variations to the present invention. Any modification, equivalent replacement, or improvement made within the spirit and principle of the present invention should fall within the protection scope of the present invention.

1. An internal deformation analysis experimental device for a three-dimensional particle material, comprising:
several particles, which are transparent solids;
an infiltration liquid, the refractive index of the particles being the same as that of the infiltration liquid;
a container, configured to accommodate the particles and the infiltration liquid;
a laser device, arranged on an outer side of the container, the infiltration liquid being able to generate fluorescent light when laser emitted by the laser device irradiates the infiltration liquid;
a recording apparatus, arranged on the outer side of the container and configured to collect and acquire a sequential image of the particles; and
a computing terminal, the recording apparatus sending the acquired sequential image of the particles to the computing terminal, and the computing terminal constructing a three-dimensional particle system through the sequential image of the particles, and acquiring three-dimensional internal deformation analysis of the three-dimensional particle system.

2. The internal deformation analysis experimental device for a three-dimensional particle material according to claim 1, wherein the container comprises a container wall; and a movable top plate capable of moving up and down relative to the container wall is arranged in the container wall.

3. The internal deformation analysis experimental device for a three-dimensional particle material according to claim 2, wherein a displacement sensor and a force sensor are mounted on the movable top plate; and the displacement sensor and the force sensor are connected with a controller, respectively.

4. The internal deformation analysis experimental device for a three-dimensional particle material according to claim 3, wherein the movable top plate is connected to a force application mechanism; and the force application mechanism is connected to the controller.

5. The internal deformation analysis experimental device for a three-dimensional particle material according to claim 1, wherein the recording apparatus is a charge coupled device (CCD) camera; a lens of the camera is provided with a light filter; and the light filter allows light having a wavelength greater than that of the laser emitted by the laser device to pass; and
an image plane of the CCD camera is parallel to the laser emitted by the laser device.

6. The internal deformation analysis experimental device for a three-dimensional particle material according to claim 3, wherein the laser device is mounted on a linear drive mechanism connected to the controller.

7. An internal deformation analysis method for a three-dimensional particle material, using the experimental device according to claim 1.

8. The internal deformation analysis method for a three-dimensional particle material according to claim 7, comprising:
selecting set particles and a set infiltration liquid;
placing particles and infiltration liquid into the container;
turning on the laser device, emitting laser to the container, applying a set load to a mixed liquid of the particles and the liquid in the container, and collecting, by the recording apparatus, sequential images of multiple layers of the particle system in different load states;
obtaining three-dimensional particle systems in different load states according to the sequential images in different load states, and applying operations of a digital volume correlation method on the reconstructed three-dimensional particle systems, so as to realize three-dimensional internal deformation analysis for of the particle system.

9. The internal deformation analysis method for a three-dimensional particle material according to claim 8, wherein the turning on the laser device, emitting laser to the container, applying a set load to a mixed liquid of the particles and the liquid in the container, and collecting, by the recording apparatus, sequential images of multiple layers of the particle system in different load states specifically comprises:
along a lengthwise direction of the container, from one side to the other side, moving the laser device once every set distance, and collecting, by the recording apparatus, the sequential images of the multiple layers of the particle system, thus obtaining a three-dimensional particle system in an original state: State 1; and
applying the set load to the mixed liquid of the particles and the liquid in the container, in each load application process, along the lengthwise direction of the container, from one side to the other side, moving the laser device once every set distance, and collecting, by the recording apparatus, the sequential images of the multiple layers of the particle system, thus obtaining three-dimensional particle systems in different load states: State 2, State 3, . . . , State N.
